(19) United States
(12) Patent Application Publication
(10) Pub. No.: US 2026/0171423 A1
(43) Pub. Date: Jun. 18, 2026

(54) ANODELESS ALL SOLID STATE BATTERY

(71) Applicants: HYUNDAI MOTOR COMPANY, Seoul (KR); KIA CORPORATION, Seoul (KR); Seoul National University R&DB Foundation, Seoul (KR)

(72) Inventors: Ji Young Kim, Hwaseong-si (KR); Jong Chan Song, Hwaseong-si (KR); Sang Heon Lee, Hwaseong-si (KR); Ki Yoon Bae, Hwaseong-si (KR); Jang Wook Choi, Seoul (KR); Ji Hoon Oh, Seoul (KR)

(73) Assignees: HYUNDAI MOTOR COMPANY, Seoul (KR); KIA CORPORATION, Seoul (KR); Seoul National University R&DB Foundation, Seoul (KR)

(21) Appl. No.: 19/230,551

(22) Filed: Jun. 6, 2025

(30) Foreign Application Priority Data
Dec. 17, 2024 (KR) 10-2024-0189164

(51) Int. Cl. H01M 4/66; H01M 10/058

(52) U.S. Cl. CPC H01M 4/662; H01M 4/667; H01M 10/058

(57) ABSTRACT

An anodeless all solid state battery includes an anode current collector, a first intermediate layer disposed on the anode current collector and including a first metal for forming a solid solution alloy with lithium, a second intermediate layer disposed on the first intermediate layer and including a second metal for forming an intermetallic alloy with lithium, a solid electrolyte layer disposed on the second intermediate layer, a cathode active material layer disposed on the solid electrolyte layer, and a cathode current collector disposed on the cathode active material layer.

### CROSS-REFERENCE TO RELATED APPLICATION

This application claims the benefit of and priority to Korean Patent Application No. 10-2024-0189164, filed in the Korean Intellectual Property Office on Dec. 17, 2024, the entire contents of which are incorporated herein by reference.

### TECHNICAL FIELD

The present disclosure provides an anodeless all solid state battery including an intermediate layer to precipitate lithium.

### BACKGROUND

A secondary battery, which is rechargeable, has been used not only in smaller electronic devices, such as a mobile phone or a laptop computer, but also in larger transportation vehicles, such as a hybrid vehicle or an electric vehicle. Accordingly, there is a need to develop a secondary battery having higher stability and an energy density.

For conventional secondary batteries, a cell is mainly formed based on an organic solvent (or an organic liquid electrolyte). Accordingly, conventional secondary batteries have a limitation in improving stability and an energy density. An all solid state battery employing an inorganic solid electrolyte is based on a technology without the organic solvent. Accordingly, all solid state batteries have been in the spotlight recently, as cells are manufactured in a stabler and simpler form.

An all solid state battery includes a cathode active material layer bonded to a cathode current collector, an anode active material layer bonded to an anode current collector, and a solid electrolyte layer interposed between the cathode active material layer and the anode active material layer. However, the anode active material layer includes a solid electrolyte for moving lithium ions in addition to the anode active material, such as graphite, and the solid electrolyte has a specific gravity higher than a specific gravity of a liquid electrolyte. Accordingly, an energy density of the all solid state battery is lower than an energy density of a lithium ion battery using the liquid electrolyte.

To increase the energy density of the all solid state battery, research and studies have been performed on an anodeless all solid state battery in a storage type to directly precipitate lithium ions on the anode current collector in the form of lithium metal, without the anode active material layer. However, when the anodeless all solid state battery is charged, lithium transmitted from the cathode is plated on the anode current collector forming a lithium dendritic crystal.

### SUMMARY

The present disclosure has been made to solve the above-mentioned problems occurring in the prior art while advantages achieved by the prior art are maintained.

An aspect of the present disclosure provides an anodeless all solid state battery capable of preventing an internal short circuit from being caused, as a lithium-plated layer is additionally formed between a solid electrolyte layer and an intermediate layer. The anodeless all solid state battery is further capable of being charged more stably even during higher-rate charging/discharging.

The technical problems to be solved by the present disclosure are not limited to the aforementioned problems, and any other technical problems not mentioned herein should be clearly understood from the following description by those having ordinary skill in the art to which the present disclosure pertains.

An aspect of the present disclosure provides an anodeless all solid state battery including an anode current collector, a first intermediate layer disposed on the anode current collector and including a first metal for forming a solid solution alloy with lithium, a second intermediate layer disposed on the first intermediate layer, and including a second metal for forming an intermetallic alloy with lithium, a solid electrolyte layer disposed on the second intermediate layer, a cathode active material layer disposed on the solid electrolyte layer, and a cathode current collector disposed on the cathode active material layer.

### BRIEF DESCRIPTION OF THE DRAWINGS

The above and other aspects, features and advantages of the present disclosure should be more apparent from the following detailed description taken in conjunction with the accompanying drawings.

FIG. 1 is a view schematically illustrating the charging state of an anodeless all solid state battery according to an embodiment of the present disclosure.

FIG. 2 illustrates an SEM image and EDS mapping for a cross-section of an anodeless all solid state battery plated with lithium according to Embodiment 1 of the present disclosure and Comparative Example 1.

FIG. 3 is a graph representing the measurement of a behavior for plating lithium in an anodeless all solid state battery according to Reference Example 1 and Reference Example 2.

FIG. 4 is a graph representing the measurement of a behavior for plating lithium in an anodeless all solid state battery according to Embodiment 1 and Comparative Example 1;

FIG. 5 is a graph representing voltage-specific capacity measured in a charging/discharging process according to Embodiment 1 and Comparative Example 1.

FIG. 6 is a graph representing a specific capacity for each cycle according to Embodiment 1 and Comparative Example 1.

### DETAILED DESCRIPTION

The present disclosure is described in more detail below for the understanding of the present disclosure. In this case, terms or words used in the present specification and the claims should not be interpreted as commonly-used dictionary meanings, but be interpreted as to be relevant to the technical scope of the present disclosure based on the fact that the inventor may properly define the concept of the terms to explain the present disclosure.

The terms used in the present disclosure are provided only for the illustrative purpose, and the present disclosure is not limited thereto. The singular forms are intended to include the plural forms unless the context clearly indicates otherwise.

In this specification, it should be further understood that the terms “comprises,” “includes,” or “has,” specify the presence of stated features, numbers, steps, components, parts, or the combination thereof, but do not preclude the presence or addition of one or more other features, numbers, steps, components, and/or the combination thereof.

When a component, controller, device, element, apparatus, module, unit or the like of the present disclosure is described as having a purpose or performing an operation, function, or the like, the component, controller, device, element, apparatus, module, unit or the like should be considered herein as being “configured to” meet that purpose or to perform that operation or function. Each component, unit, controller, device, element, apparatus, module, and the like may separately embody or be included with a processor and a memory, such as a non-transitory computer readable media, as part of the apparatus.

The present disclosure provides an anodeless all solid state battery.

According to an embodiment of the present disclosure, an anodeless all solid state battery at least includes an anode current collector, a first intermediate layer disposed on the anode current collector and including a first metal for forming a solid solution alloy with lithium, a second intermediate layer disposed on the first intermediate layer, and including a second metal for forming an intermetallic alloy with lithium, a solid electrolyte layer disposed on the second intermediate layer, a cathode active material layer disposed on the solid electrolyte layer, and a cathode current collector disposed on the cathode active material layer.

An all solid state battery includes a cathode active material layer bonded to a cathode current collector, an anode active material layer bonded to an anode current collector, and a solid electrolyte layer interposed between the cathode active material layer and the anode active material layer. However, the anode active material layer includes a solid electrolyte for moving lithium ions, in addition to the anode active material, such as graphite, and the solid electrolyte has a specific gravity higher than a specific gravity of a liquid electrolyte. Accordingly, an energy density of the all solid state battery is lower than an energy density of a lithium ion battery using the liquid electrolyte.

As indicated above, to increase the energy density of a solid state battery, research and studies have been recently performed on an anodeless all solid state battery in a storage type to directly precipitate lithium ions on the anode current collector in the form of lithium metal.

A conventional anodeless all solid state battery includes an intermediate layer interposed between a solid electrolyte layer and an anode current collector and further includes a carbon material to uniformly precipitate and plate lithium. When charging the anodeless all solid state battery, lithium ions (Li+) of the cathode reach the intermediate layer through the solid electrolyte layer. The lithium ions (Li+) react with the carbon material, move, and then precipitate between the anode current collector and the intermediate layer. However, when typical graphite is included as a carbon material in the intermediate layer of the anodeless all solid state battery, active lithium is consumed due to uncontrolled lithium dendritic growth and a side reaction, and lithium ions are precipitated between the solid electrolyte layer and the intermediate layer due to the crystallinity of graphite, thereby causing an internal short circuit. Accordingly, the lifespan of the anodeless all solid state battery may be shortened.

According to an embodiment of the present disclosure, the anodeless all solid state battery may include a first intermediate layer including a first metal for forming a solid solution alloy with lithium and a second intermediate layer including a second metal for forming an intermetallic alloy with lithium, thereby preventing an internal short circuit caused as a lithium-plated layer is additionally formed between a solid electrolyte layer and an intermediate layer, such that the anodeless all solid state battery is more stably charged.

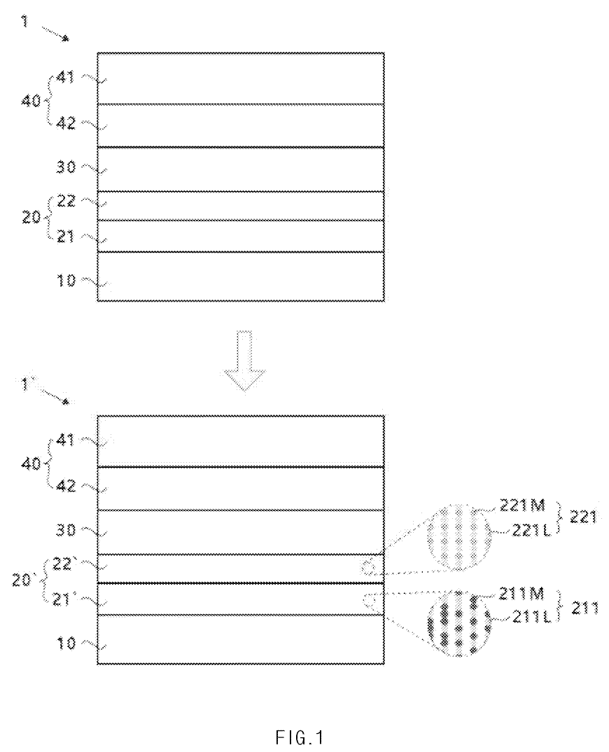

Components constituting the anodeless all solid state battery according to an embodiment of the present disclosure are described in detail below with reference to FIG. 1. FIG. 1 is a view schematically illustrating the charging state of an anodeless all solid state battery according to an embodiment of the present disclosure. FIG. 1 illustrates an anodeless all solid state battery 1 in an initial state (in other words, a fully-discharged state before initially charging) and an anodeless all solid state battery 1′ which is in progress of charging. Each component of the anodeless all solid state battery according to an embodiment of the present disclosure is described while focusing on the anodeless all solid state battery 1 in the initial state unless defined otherwise.

### Anode Current Collector

According to an embodiment of the present disclosure, an anode current collector 10, which serves as a plate-shaped substrate having electrical conductivity, may include a material that does not react with lithium. Specifically, the anode current collector 10 includes various materials without being specially limited, as long as the materials have conductivity without inducing a chemical change in a relevant battery (or the anodeless all solid state battery according to the present disclosure). For example, the anode current collector 10 may be aluminum (Al), nickel (Ni), titanium (Ti), tungsten (W), iron (Fe), chromium (Cr), or stainless steel, or an alloy thereof.

### Intermediate Layer

According to an embodiment of the present disclosure, an intermediate layer 20, which is a component directly disposed on the anode current collector 10, may induce lithium metal to be plated in a horizontal direction along the surface of the anode current collector 10, when lithium ions are precipitated in the form of lithium metal on the surface of the anode current collector 10.

According to an embodiment of the present disclosure, the intermediate layer 20 may include a first intermediate layer 21 and a second intermediate layer 22 disposed on the first intermediate layer 21.

According to an embodiment of the present disclosure, the first intermediate layer 21, which is a component directly disposed on the anode current collector 10, may be a space for mainly plating lithium in a charging process of the anodeless all solid state battery.

According to an embodiment of the present disclosure, the first intermediate layer 21 may include the first metal for forming the solid solution alloy in reaction with the lithium ions. The solid solution alloy has a lithium-ion diffusion coefficient higher than a lithium-ion diffusion coefficient of the intermetallic alloy in the second intermediate layer 22 described below. Accordingly, the lithium is first plated on the first intermediate layer 21, thereby preventing the lithium plating from making direct contact with a solid electrolyte layer 30. According to the present disclosure, the solid solution alloy refers to an alloy phase in which at least one solid material is disorderly mixed into another solid solvent, without forming a new crystal structure (i.e., the metallic elements fail to establish a crystallography structure with periodic repetition of unit cells).

According to an embodiment of the present disclosure, the first metal may be magnesium (Mg), silver (Ag), cadmium (Cd), or an alloy thereof. Specifically, in one example, the first metal may be magnesium (Mg).

According to an embodiment of the present disclosure, the first intermediate layer 21 may be formed by sputtering or by chemical vapor deposition.

According to an embodiment of the present disclosure, the first intermediate layer 21 may have a thickness in a range of 100 nm to 300 nm. Specifically, in some examples, the first intermediate layer 21 has the thickness of at least 200 nm, at least 300 nm, at least 400 nm, at least 500 nm, or at least 600 nm. In some examples, the first intermediate layer 21 has the thickness of at most 2,800 nm, at most 2,600 nm, at most 2,400 nm, at most 2,200 nm, at most 2,000 nm, or at most 1,500 nm. When the first intermediate layer 21 satisfies the above range or ranges, the lithium may be more effectively plated.

According to an embodiment of the present disclosure, the first intermediate layer 21 may have a thickness greater than a thickness of the second intermediate layer 22. In this case, the lithium may be more effectively plated.

According to an embodiment of the present disclosure, the second intermediate layer 22, which is a component directly disposed on the first intermediate layer 21, may induce lithium ions to be plated on the first intermediate layer 21 and may prevent the solid electrolyte layer 30 from making direct contact with lithium plating, thereby preventing a lithium dendritic from being grown.

According to an embodiment of the present disclosure, the second intermediate layer 22 may include the second metal for forming the intermetallic alloy in reaction with the lithium ions. The intermetallic alloy has a lithium-ion diffusion coefficient lower than the lithium-ion diffusion coefficient of the solid solution alloy. Accordingly, the intermetallic alloy may induce lithium from being first plated on the first intermediate layer 21, thereby preventing the lithium plating from making direct contact with the solid electrolyte layer 30. According to the present disclosure, the intermetallic alloy refers to an alloy phase in which at least two metal elements are provided to form a crystal structure having a regular arrangement between the metal elements.

According to an embodiment of the present disclosure, the second metal may be gold (Au), zinc (Zn), silicon (Si), tin (Sn), aluminum (Al), germanium (Ge), or an alloy thereof. Specifically, in one example, the second metal may be gold (Au).

According to an embodiment of the present disclosure, the second intermediate layer 22 may be formed by sputtering or by chemical vapor deposition.

According to an embodiment of the present disclosure, the second intermediate layer 22 may have a thickness smaller than the thickness of the first intermediate layer 21. In this case, lithium may be more easily induced to be first plated on the first intermediate layer 21 regardless of the electrical conductivity of the second intermediate layer 22, thereby more easily preventing the solid electrolyte layer 30 from making direct contact with the lithium plating.

According to an embodiment of the present disclosure, the second intermediate layer 22 may have a thickness in a range of 5 nm to 50 nm. Specifically, in some examples, the second intermediate layer 22 may be at least 6 nm, at least 7 nm, at least 8 nm, at least 9 nm, at least 10 nm, or at most 48 nm, at most 46 nm, at most 44 nm, at most 42 nm, at most 40 nm, or at most 35 nm. When the thickness of the second intermediate layer 22 satisfies the above range or ranges, the lithium may be more effectively plated.

According to an embodiment of the present disclosure, the anodeless all solid state battery 1′ being in progress of charging includes an intermediate layer 20′ including a first intermediate layer 21′ and a second intermediate layer 22′. The first intermediate layer 21′ may be formed of a solid solution alloy of lithium and the first metal 211. The second intermediate layer 22′ may be formed of an intermetallic alloy of lithium and the second metal 221.

According to an embodiment of the present disclosure, the solid solution alloy of lithium and the first metal 211 may include a first metal 211M and lithium 211L. Referring to FIG. 1, the first metal 211M and lithium 211L may be disorderly mixed in the solid solution alloy of lithium and the first metal 211.

According to an embodiment of the present disclosure, the lithium-second intermetallic alloy 221 may include a second metal 221M and the lithium 221L. Referring to FIG. 1, the second metal 221M and the lithium 221L may be regularly arranged in the lithium-second intermetallic alloy 221 (i.e., the metallic elements form a crystallographic structure exhibiting periodic repetition of unit cells).

According to an embodiment of the present disclosure, the solid solution alloy of lithium and the first metal 211 has a lithium-ion diffusion coefficient higher than a lithium-ion diffusion coefficient of the intermetallic alloy of lithium and the second metal 221. Accordingly, lithium may be first induced to be plated on the first intermediate layer 21′ including the solid solution alloy of lithium and the first metal 211. In addition, the second intermediate layer 22′ is interposed between the first intermediate layer 21′ and the solid electrolyte layer 30. When lithium is plated on the first intermediate layer 21′, the lithium plating may be prevented from making direct contact with the solid electrolyte layer 30, due to the second intermediate layer 22′.

According to an embodiment of the present disclosure, the solid solution alloy of lithium and the first metal 211 has a lithium-ion diffusion coefficient of at least 1.0×10⁻⁸ cm²/s, and specifically, may be at least 2.0×10⁻⁸ cm²/s, at least 4.0×10⁻⁸ cm²/s, at least 6.0×10⁻⁸ cm²/s, at least 8.0×10⁻⁸ cm²/s, at least 1.0×10⁻⁷ cm²/s, or at most 1.0×10⁻⁵ cm²/s, at most 8.0×10⁻⁶ cm²/s, at most 6.0×10⁻⁶ cm²/s, at most 4.0×10⁻⁶ cm²/s, at most 2.0×10⁻⁶ cm²/s, or at most 1.0×10⁻⁶ cm²/s. When the above is satisfied, the lithium may be more effectively plated.

According to an embodiment of the present disclosure, the intermetallic alloy of lithium and the second metal 221 has a lithium-ion diffusion coefficient of at least 1.0×10⁻¹⁰ cm²/s, and specifically, may be at most 8.0×10⁻¹¹ cm²/s, at most 6.0×10⁻¹¹ cm²/s, at most 4.0×10⁻¹¹ cm²/s, at most 2.0×10⁻¹¹ cm²/s, at most 1.0×10⁻¹¹ cm²/s, or at least 2.0×10⁻¹³ cm²/s, at least 4.0×10⁻¹³ cm²/s, at least 6.0×10⁻¹³ cm²/s, at least 8.0×10⁻¹³ cm²/s, or at least 1.0×10⁻¹² cm²/s. When the above is satisfied, the lithium may be more effectively plated.

### Solid Electrolyte Layer

According to an embodiment of the present disclosure, the anodeless all solid state battery may include the solid electrolyte layer 30. The solid electrolyte layer 30 may be interposed between a cathode active material layer 42 and the intermediate layer 20 to transfer lithium ions which are present between the cathode active material layer 42 and the anode current collector 10.

According to an embodiment of the present disclosure, the solid electrolyte layer 30 may be disposed on the intermediate layer 20 and may include a solid electrolyte having lithium ion conductivity. The solid electrolyte includes an oxide-based solid electrolyte, a sulfide-based solid electrolyte, a polymer electrolyte, or a combination thereof, and in one example may include the sulfide-based solid electrolyte.

According to an embodiment of the present disclosure, the sulfide-based solid electrolyte may include Li₆PS₅X (X=chlorine (Cl), bromine (Br) or iodine (I)), Li₁₀GeP₂S₁₂, Li₃PS₄, Li₇P₃S₁₁, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which ‘m’ and ‘n’ are positive numbers; Z is one of Ge, Zn, and gallium (Ga)), Li₂S—GeS₂, Li₂S—SiS₂—Li₃PO₄, Li₂S—SiS₂-LiₓMO_{y} (in which ‘x’ and ‘y’ are positive numbers; M is P, Si, Ge, B, Al, Ga, or indium (In)), or a combination thereof (where Li=lithium, P=phosphorous, S=sulfur, O-oxygen, B=boron).

### Cathode

According to an embodiment of the present disclosure, a cathode 40 may include a cathode current collector 41 and the cathode active material layer 42.

Specifically, the cathode current collector 41 may include various materials without being specially limited, as long as the materials have conductivity without inducing a chemical change in the relevant battery. For example, the cathode current collector 41 may be aluminum (Al), nickel (Ni), titanium (Ti), tungsten (W), iron (Fe), chromium (Cr), stainless steel, or an alloy thereof.

According to an embodiment of the present disclosure, the cathode active material layer 42 may include a cathode active material, a conductive material, and a binder.

According to an embodiment of the present disclosure, the cathode active material, which allows lithium ions (Lit) to be reversibly plated or released, may include a composite oxide (or a lithium composite metal oxide) of lithium and metal. Specifically, the lithium composite metal oxide may be a lithium-manganese-based oxide (e.g., LiMnO₂ or LiMn₂O₄), a lithium-cobalt-based oxide (e.g., LiCoO₂), a lithium-nickel-based oxide (e.g., LiNiO₂), a lithium-nickel-manganese-based oxide (e.g., LiNi_{1-Y}Mn_{Y}O₂ (0<Y<1), or LiMn_{2-z}Ni₂O₄ (0<Z<2)), a lithium-nickel-cobalt-based oxide (e.g., LiNi_{1-Y1}Co_{Y1}O₂ (0<Y1<1)), a lithium-manganese-cobalt-based oxide (e.g., LiCo_{1-Y2}Mn_{Y2}O₂ (0<Y2<1), or LiMn_{2-z1}Co_{z1}O₄ (0<Z1<2)), a lithium-nickel-manganese-cobalt-based oxide (e.g., Li(NiₚCo_{q}Mnᵣ₁)O₂ (0<p<1, 0<q<1, 0<r1<1, and p+q+r1=1) or Li(Niₚ₁Co_{q1}Mnᵣ₂)O₄ (0<p1<2, 0<q1<2, 0<r2<2, and p1+q1++2=2)), or a lithium-nickel-cobalt-transition metal (M) oxide (e.g., Li(Niₚ₂Co_{q2}Mnᵣ₃Mₛ₂)O₂ (‘M’ is Al, Fe, vanadium (V), Cr, Ti, Ta, Mg, and molybdenum (Mo); p2, q2, r3 and s2 are atomic fractions of independent elements; 0<p2<1, 0<q2<1, 0<r3<1, 0<s2<1, and p2+q2+r3+s2=1)), or may include any one of the above materials or a compound including at least two of the above materials.

Among them, the lithium composite metal oxide may be LiCoO₂, LiMnO₂, LiNiO₂, a lithium nickel manganese cobalt oxide (e.g., Li(Ni_{1/3}Mn_{1/3}CO_{1/3})O₂, Li(Ni_{0.6}Mn_{0.2}Co_{0.2})O₂, Li(Ni_{0.5}Mn_{0.3}CO_{0.2})O₂, Li(Ni_{0.7}Mn_{0.15}Co_{0.15})O₂ and Li(Ni_{0.8}Mn_{0.1}CO_{0.1})O₂), or a lithium nickel cobalt aluminum oxide (e.g., Li(Ni_{0.8}Co_{0.15}Al_{0.05})O₂) to enhance a capacity characteristic and stability of a battery. When considering an effect remarkably improved by controlling the type and content ratio of components forming the lithium composite metal oxide, the lithium nickel manganese cobalt oxide may be Li(Ni_{0.6}Mn_{0.2}CO_{0.2})O₂, Li(Ni_{0.5}Mn_{0.3}CO_{0.2})O₂, Li(Ni_{0.7}Mn_{0.15}CO_{0.15})O₂, and Li(Ni_{0.8}Mn_{0.1}Co_{0.1})O₂, or may employ any one of the above materials, or a mixture of at least two of the above materials.

According to an embodiment of the present disclosure, the cathode active material may include boron (B) or LiNbO (where Nb=niobium), and may further include a coating layer surrounding the lithium composite metal oxide. As the coating layer is further included, the structural stability of the cathode active material may be improved.

In addition, according to an embodiment of the present disclosure, the cathode active material layer 42 may further include a solid electrolyte. The solid electrolyte may coat the cathode active material. Accordingly, the interfacial compatibility between the cathode active material layer 42 and the solid electrolyte layer 30 described above may be improved. The details of the solid electrolyte are the same as the details of the solid electrolyte in the above description about the solid electrolyte layer 30. Therefore, the details of the solid electrolyte are omitted.

According to an embodiment of the present disclosure, the conductive material may serve to further improve the conductivity of the cathode active material. The conductive material may include various materials without being specially limited, as long as the materials have conductivity without inducing a chemical change in the relevant battery. For example, the conductive material may include graphite; a carbon-based material, such as carbon black, acetylene black, ketjen black, channel black, furnace black, lamp black, thermal black, and SC65; a conductive fiber such as a carbon fiber or a metal fiber; metal powders such as carbon fluoride, aluminum or nickel powders; conductive whisker such as a zinc oxide or potassium titanate; conductive metal oxide such as titanium oxide; and a conductive material such as a polyphenylene derivative.

According to an embodiment of the present disclosure, the binder may facilitate bonding among the conductive material, the cathode active material, and the cathode current collector. The binder may be polyvinylidene fluoride, polyvinyl alcohol, carboxymethylcellulose, starch, hydroxypropylcellulose, regenerated cellulose, polyvinylpyrrolidone, tetrafluoroethylene, polyethylene, polypropylene, ethylene-propylene-diene monomer, sulfonated ethylene-propylene-diene monomer, styrene-butadiene rubber, nifril-butadiene rubber, fluorine rubber, and various copolymers thereof.

An embodiment of the present disclosure is described in detail such that those having ordinary skill in the art may easily reproduce the embodiment of the present disclosure. However, the present disclosure may be implemented in various forms, and is not limited to embodiments described herein.

### Example 1

After preparing an anode current collector formed of stainless-steel foil, 200 nm of magnesium (Mg) thin film (first intermediate layer) was formed on the surface of the anode current collector through a direct current (DC) sputtering process. Thereafter, 30 nm of gold (Au) thin film (second intermediate layer) was formed on the surface of the Mg thin film through the DC sputtering process, thereby manufacturing an electrode. Additionally, 100 mg of solid electrolyte powders including Li₆PS₅Cl was put into a mold having an inner diameter of 10 mm, and compressed at 200 MPa, thereby manufacturing a solid electrolyte layer on the surface of the formed gold (Au) thin film. Thereafter, 20 mg of powders of a cathode active material (LiNi_{0.8}Co_{0.1}Mn_{0.1}O₂), a solid electrolyte (Li₆PS₅Cl_{0.5}Br_{0.5}) and a conductive material (Vapor Grown Carbon Fiber, VGCF), which were mixed with each other at a ratio of 70:28:2, were compressed at 200 MPa, thereby forming the cathode active material layer on the solid electrolyte layer. After preparing the cathode current collector having the thickness of 10 μm and including Al, the cathode current collector was matched against one surface of the manufactured cathode active material layer, and the result was compressed at 380 MPa to form the cathode current collector, thereby manufacturing the anodeless all solid state battery.

### Comparative Example 1

After preparing an anode current collector formed of stainless-steel foil, 200 nm of gold (Au) thin film (first intermediate layer) was formed on the surface of the anode current collector through a DC sputtering process. Thereafter, 30 nm of Mg thin film (second intermediate layer) was formed on the surface of the Au thin film through the DC sputtering process, thereby manufacturing an electrode. Additionally, 90 mg of solid electrolyte powders including Li₆PS₅Cl was put into a mold having an inner diameter of 10 mm, and compressed at 200 MPa, thereby manufacturing a solid electrolyte layer on the surface of the formed Mg thin film. Thereafter, 20 mg of powders of a cathode active material (LiNi_{0.8}Co_{0.1}Mn_{0.1}O₂), a solid electrolyte (Li₆PS₅Cl_{0.5}Br_{0.5}) and a conductive material (VGCF), which were mixed with each other at a ratio of 70:28:2, were compressed at 200 MPa, thereby forming the cathode active material layer on the solid electrolyte layer. After preparing the cathode current collector having the thickness of 10 μm and including Al, the cathode current collector was matched against one surface of the manufactured cathode active material layer, and the result was compressed at 380 MPa to form the cathode current collector, thereby manufacturing the anodeless all solid state battery.

### Reference Example 1

After preparing an anode current collector formed of stainless-steel foil, 30 nm of gold (Au) thin film was formed on the surface of the anode current collector through a DC sputtering process. Additionally, 100 mg of solid electrolyte powders including Li₆PS₅Cl was put into a mold having an inner diameter of 10 mm, and compressed at 380 MPa, thereby manufacturing a solid electrolyte layer on the surface of the formed Au thin film. Thereafter, a lithium metal electrode was positioned on the solid counter electrode, thereby electrolyte layer to form a manufacturing an anodeless solid state half-cell.

### Reference Example 2

After preparing an anode current collector formed of stainless-steel foil, 30 nm of magnesium (Mg) thin film was formed on the surface of the anode current collector through a DC sputtering process. Additionally, 100 mg of solid electrolyte powders including Li₆PS₅Cl was put into a mold having an inner diameter of 10 mm, and compressed at 380 MPa, thereby manufacturing a solid electrolyte layer on the surface of the formed Mg thin film. Thereafter, a lithium metal electrode was positioned on the solid electrolyte layer to form a counter electrode, thereby manufacturing an anodeless solid state half-cell.

### Experimental Example 1

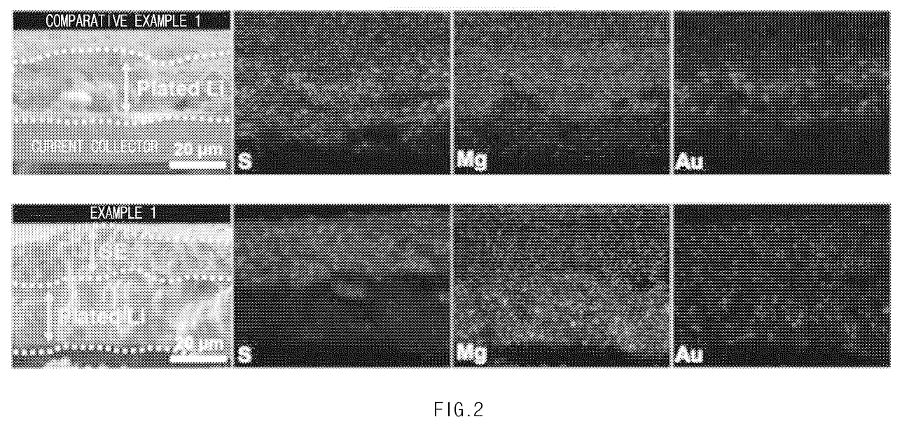

For the anodeless all solid state battery manufactured according to each of Example 1 and Comparative Example 1, after lithium having a capacity of 1.0 mA/cm² was plated at a current density of 1.0 mA/cm² under the condition of 25° C. and 20 MPa, Scanning Electron Microscopy (SEM) images and Energy Dispersive X-ray Spectroscopy (EDS) mapping of the electrode cross section are illustrated in FIG. 2 through an SEM-EDS. As SEM-EDS equipment, JSM-7800F Prime from JEOL was used.

Referring to FIG. 2, it is recognized that a region plated with lithium and the solid electrolyte region are definitely distinguished from each other in the anodeless all solid state battery according to Example 1. Accordingly, it may be recognized that a lithium dendrite is not formed, as a lithium plating is prevented from making direct contact with the solid electrolyte region. To the contrary, it is recognized that the region plated with lithium and the solid electrolyte region are mixed together in the anodeless all solid state battery according to Comparative Example 1. Accordingly, it is recognized that a lithium dendrite is formed, as the lithium plating makes direct contact with the solid electrolyte region. It is expected that this phenomenon results from the Li—Mg alloy (in a solid alloy phase) having a lithium ion diffusion coefficient higher than a lithium ion diffusion coefficient of the Li—Au alloy (in an intermetallic alloy phase).

### Experimental Example 2

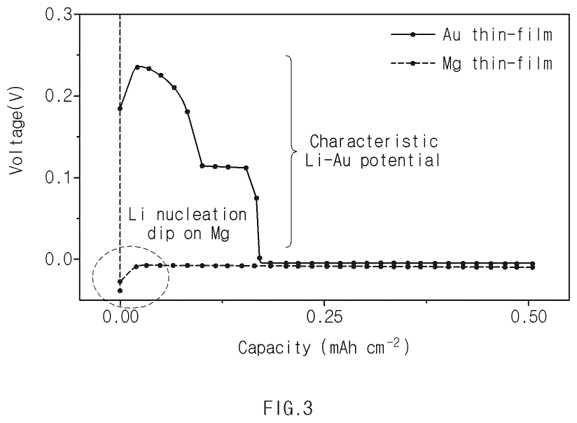

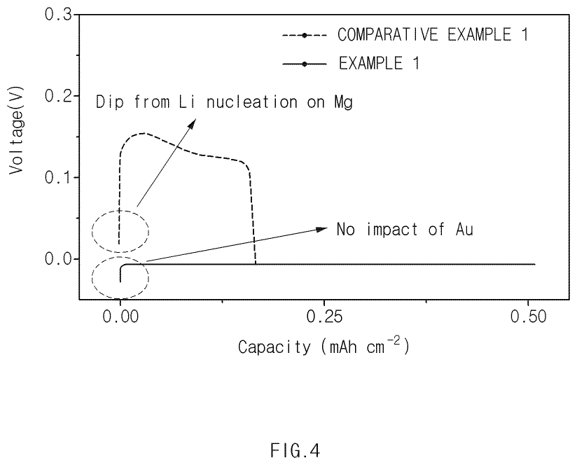

The anodeless all solid state battery manufactured according to each of Reference Example 1, Reference Example 2, Example 1, and Comparative Example 1 was charged at a current density of 1.0 mA/cm² under the condition of 25° C. and 20 MPa, and graphs representing a voltage-areal capacity are shown in FIGS. 3 and 4.

Referring to FIGS. 3 and 4, it is recognized that the anodeless all solid state battery according to Example 1 was dominant in a lithium alloy reaction to the Mg thin film without a voltage behavior resulting from a lithium alloy reaction to the Au thin film, and it is recognized that the anodeless all solid state battery according to Comparative Example 1 showed the lithium alloy reaction to the Au thin film, after the lithium alloy reaction to the Mg thin film in the initial stage. Accordingly, it is recognized that the lithium alloy reaction was more advantageous for the Mg thin film, rather than the Au thin film. In addition, it is recognized that the lithium was first plated at a part adjacent to the anode current collector, as the Mg thin film was positioned to be adjacent to the anode current collector.

### Experimental Example 3

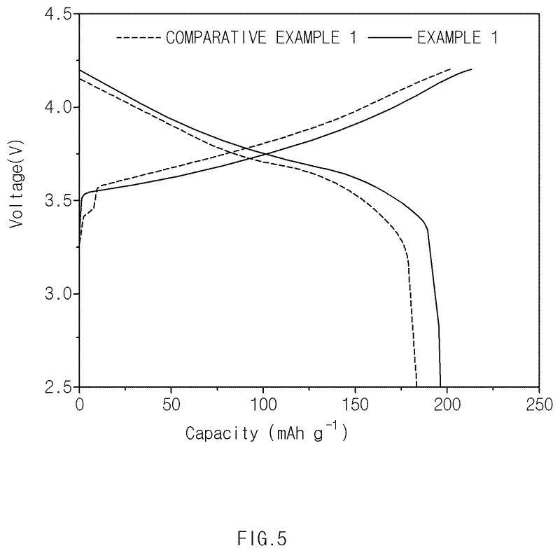

Each of the anodeless all solid state batteries according to Example 1 and Comparative Example 1 were charged at 0.1 C (1 C=3.5 mA/cm²) until 4.2 V, and discharged at 0.1 C (1 C=3.5 mA/cm²) until 2.5 V, in the CC-CV mode at 25° C. In this case, the graph representing the relationship between a voltage and a specific capacity is shown in FIG. 5.

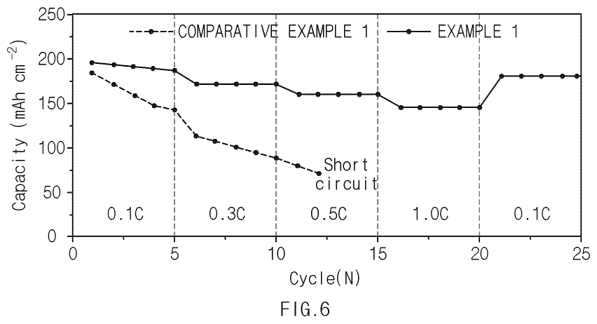

Each of the anodeless all solid state batteries according to Example 1 and Comparative Example 1 was charged at 0.1 C (1 C=3.5 mA/cm²) until 4.2 V, and discharged at 0.1 C (1 C=3.5 mA/cm²) until 2.5 V, in the CC-CV mode at 25° C., in a 1^{st} cycle to a 5^{th} cycle, was charged at 0.3 C (1 C=3.5 mA/cm²) until 4.2 V, and discharged at 0.3 C (1 C=3.5 mA/cm²) until 2.5 V, in the CC-CV mode at 25° C., in a 6^{th} cycle to a 10^{th} cycle, was charged at 0.5 C (1 C=3.5 mA/cm²) until 4.2 V, and discharged at 0.5 C (1 C=3.5 mA/cm²) until 2.5 V, in the CC-CV mode at 25° C., in a 11^{th} cycle to a 15^{th} cycle, was charged at 1 C (=3.5 mA/cm²) until 4.2 V, and discharged at 1 C (=3.5 mA/cm²) until 2.5 V, in the CC-CV mode at 25° C., in a 16^{th} cycle to a 20^{th} cycle, and was charged at 0.1 C (1 C=3.5 mA/cm²) until 4.2 V, and discharged at 0.1 C (1 C=3.5 mA/cm²) until 2.5 V, in the CC-CV mode at 25° C., in a 21^{st} cycle to a 25^{th} cycle. In this case, the graph illustrating a specific capacity for each cycle is shown in FIG. 6.

Referring to FIG. 5, it is recognized that the anodeless all solid state battery according to Example 1 exhibited an excellent charging/discharging capacity, when compared to the anodeless all solid state battery according to Comparative Example 1. In addition, referring to FIG. 6, it is recognized that the anodeless all solid state battery according to Comparative Example 1 caused the internal short circuit in the 12^{th} cycle, but the anodeless all solid state battery according to Example 1 was charged regardless of a charging/discharging rate.

As described above, according to an example of the present disclosure, the anodeless all solid state battery may prevent the internal short circuit from being caused, as the lithium-plated layer is additionally formed between the solid electrolyte layer and the intermediate layer, and may be charged more stably even during higher-rate charging/discharging.

Although the present disclosure has been described with reference to examples and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. An anodeless all solid state battery comprising:
an anode current collector;
a first intermediate layer disposed on the anode current collector, the first intermediate layer including a first metal configured to form a solid solution alloy with lithium;
a second intermediate layer disposed on the first intermediate layer, the second intermediate layer including a second metal configured to form an intermetallic alloy with lithium;
a solid electrolyte layer disposed on second intermediate layer;
a cathode active material layer disposed on the solid electrolyte layer; and
a cathode current collector disposed on the cathode active material layer.

2. The anodeless all solid state battery of claim 1, wherein the first metal comprises magnesium (Mg), silver (Ag), cadmium (Cd), or an alloy of magnesium (Mg), silver (Ag), or cadmium (Cd).

3. The anodeless all solid state battery of claim 1, wherein the second metal comprises gold (Au), zinc (Zn), silicon (Si), tin (Sn), aluminum (Al), germanium (Ge), or an alloy of gold (Au), zinc (Zn), silicon (Si), tin (Sn), aluminum (Al), or germanium (Ge).

4. The anodeless all solid state battery of claim 1, wherein the first intermediate layer includes a solid solution alloy of lithium and the first metal, and
wherein the second intermediate layer includes an intermetallic alloy of lithium and the second metal.

5. The anodeless all solid state battery of claim 4, wherein the solid solution alloy of lithium and the first metal has a lithium ion diffusion coefficient higher than a lithium ion diffusion coefficient of the intermetallic alloy of lithium and the second metal.

6. The anodeless all solid state battery of claim 4, wherein the solid solution alloy of lithium and the first metal has a lithium ion diffusion coefficient of at least 1.0×10⁻⁸ cm²/s.

7. The anodeless all solid state battery of claim 4, wherein the intermetallic alloy of lithium and the second metal has a lithium ion diffusion coefficient of at least 1.0×10⁻¹⁰ cm²/s.

8. The anodeless all solid state battery of claim 1, wherein the first intermediate layer has a thickness greater than a thickness of the second intermediate layer.

9. The anodeless all solid state battery of claim 1, wherein the first intermediate layer has a thickness in a range of 100 nm to 3,000 nm.

10. The anodeless all solid state battery of claim 1, wherein the second intermediate layer has a thickness in a range of 5 nm to 50 nm.
